(19) United States
(12) Patent Application Publication
(10) Pub. No.: US 2022/0260407 A1
(43) Pub. Date: Aug. 18, 2022

(54) Monitoring Device

(71) Applicant: The Smart Container Company Limited, Pontypridd (GB)

(72) Inventors: Orlando Ferrer, Pontypridd (GB); Eduardo Garcia, Pontypridd (GB)

(73) Assignee: The Smart Container Company Limited, Pontypridd (GB)

(21) Appl. No.: 17/624,341

(22) PCT Filed: Jun. 17, 2020
(86) PCT No.: PCT/EP2020/066840

§ 371 Date: Jan. 1, 2022

(30) Foreign Application Priority Data
Jul. 4, 2019 (GB) 1909617.1

(51) Int. Cl. G01F 23/2962; G01F 23/80; G01D 11/24; G01D 11/30; G01D 21/02

(52) U.S. Cl. CPC G01F 23/2962; G01F 23/804; G01D 21/02; G01D 11/30; G01D 11/245

(57) ABSTRACT

A device for attaching to a container for storing a fluid, wherein the device comprises one or more sensors for measuring a parameter of the fluid or the container, and wherein the device has a flexible outer construction for conforming to curvature of an upper or lower rim of a container having a substantially cylindrical or barrel shape.

### CROSS-REFERENCE TO RELATED APPLICATIONS

This application is the National Stage of International Patent Application No. PCT/EP2020/066840, filed Jun. 17, 2020, which claims priority to and all the advantages of British Patent Application No. GB 1909617.1, filed Jul. 4, 2019, the entire contents of which are hereby incorporated by reference.

### TECHNICAL FIELD

The present invention relates to a system for monitoring the contents of a container, and more specifically to monitoring the liquid consumable contents of a container.

### BACKGROUND TO THE INVENTION

Systems for tracking assets are widely used. Such systems can provide useful information to establish the location of various goods as they progress through a supply chain and often utilise RFID tags which may require manual scanning. Although these systems can and help minimise losses and damage, they do not provide much insight regarding the state of the goods or products themselves and are therefore generally ill-suited for consumable products.

Other devices and systems are known which facilitate the determination of the quantity and quality of a product at various points in the supply chain (and often other variables relating to the product, such as location and temperature). However, such devices and systems which are known in the art are limited in their application, have a high implementation cost and do not facilitate the extraction of useful information at all stages of the supply chain. It is an aim of the present invention to avoid, or at least mitigate, deficiencies of the prior art.

### SUMMARY OF THE INVENTION

According to a first aspect of the invention, there is provided a device for attaching to a container for storing a fluid, wherein the device comprises one or more sensors for measuring a parameter of the fluid or the container, and wherein the device has a flexible outer construction for conforming to curvature of an upper or lower rim of a container having a substantially cylindrical or barrel shape.

Preferably, the device comprises multiple segments, wherein the multiple segments are connected by a flexible material. The device preferably has a generally arcuate shape having a degree of curvature. The flexible material preferably allows the degree of curvature to be varied. Optionally, a first segment houses a processing unit, a second segment houses a wireless communication module, a third segment houses a power source and a fourth segment houses one of an accelerometer and a temperature monitor. The device preferably further comprises an ultrasonic transducer transceiver. The device optionally comprises one or more radial arms, wherein at least one of the one or more radial arms comprise the ultrasonic transducer transceiver, such that, when the device is positioned under a rim of a container, the one or more radial arms extend towards the central longitudinal axis of the container. The device may further comprise a light source, preferably wherein the light source is an LED. The device may also further comprise means for outputting audio and/or a thermoelectric generator, wherein the thermoelectric generator is configured to charge the at least one battery during cleaning of the container and/or a piezoelectric component, wherein the piezoelectric component is configured to harvest kinetic energy during cleaning of the container.

According to a second aspect of the invention, there is provided a device for monitoring liquid in a container, comprising temperature detection means for detecting temperature; movement detection means for detecting movement of the device; volume determination means for determining the volume of liquid in the container; wireless communication means for communicating with an external computing system; and processing means for processing data from the temperature detection means, movement detection means and volume determination means, wherein the processing means is in communication with the wireless communication means; wherein the processor means is configured to control the operation of the temperature detection means, movement detection means and volume determination means and transmit data to the external computer system according to a set of rules, wherein the set of rules is determined based on the usage state of the container.

In a first usage state, the data is preferably collected and transmitted according to a sliding mode control process. In a second usage state, the data is preferably collected and transmitted according to a time series forecasting process. The usage state of the device is preferably determined based on an interrupt event detected by the movement detection means and/or is based on a change in a measurement of the volume of the liquid in the container by the volume determination means. When the container is in a first usage state, the processing means is optionally configured to instruct the volume detection means to detect volume according to a time series forecasting pattern. When the container is in a second usage state, the processing means is optionally configured to instruct the movement detection means to determine the movement of the contents of the container according to a sliding mode control process. When the container is in a third usage state, the processing means is optionally configured to instruct the temperature detection means to determine the temperature of the contents of the container according to a sliding mode control process.

According to a third aspect of the invention, there is a provided a system for power conservation for a device, wherein the system comprises: a device for monitoring the liquid contents of a container, and an external computing system, wherein the device comprises: temperature sensing means for sensing temperature; movement detection means for detecting movement of the device; volume determination means for determining the volume of liquid in the container; wireless communication means for communicating with an external computing system; and processing means in communication with the communication means, wherein the processing means is configured to control the operation of the temperature detection means, wireless signal detection means, movement detection means and volume determination means, store and transmit data to the external computer system according to a set of rules, wherein the set of rules is determined based on the usage state of the device.

Preferably, the external computing system is configured to receive location data relating to one or more network gateways proximal to the device, and may be further configured to receive data relating to the signal strength of a signal transmitted from the wireless communication module and received by the network gateway. The external computing system may be configured to determine a location of the device based on the signal strength and data relating to the location of the one or more network gateways. The communication means preferably communicates with the external computing system using an internet of things network and is preferably configured to detect a wide area network gateway.

According to a fourth aspect of the invention, there is provided a method of power management for a device for monitoring the liquid contents of a container, comprising determining a usage state of the device, wherein if is it determined that the device is in the first usage state, recording or measuring a first parameter of the contents of the container and transmitting the parameter to an external computing system according to a sliding mode control process, and if it is determined that the device is in a second usage state, recording or measuring a parameter of the contents of the container and transmitting the parameter to an external computing system according to a time series forecasting process. Preferably, the first parameter is temperature and the second parameter is volume.

According to a fifth aspect of the invention, there is provided a system for determining the volume of liquid contained in container, comprising a device arranged to measure the time of flight of an ultrasonic signal reflected from a surface of the liquid contained in the container, and to transmit the time of flight data to an external computing system; an external computing system in communication with the device, wherein the external computing system is arranged to store dimensions of multiple types of container, wherein the external computing system is further configured to receive the time of flight data, determine the height of the liquid contained in the container based on the time of flight data, determine dimensions of the container based on the determined height of the liquid contained in the container, and calculate, for a determined height of the liquid contained in the container, the volume of the liquid stored in the container using the determined keg dimensions.

According to a sixth aspect of the invention, there is provided a method of monitoring a liquid contained in a container, comprising emitting an ultrasonic signal from the bottom of the container and receiving the signal at the bottom of the container, reflected by an interface between gas and liquid at the surface of the liquid contained in the container; determining the height of the liquid contained in the container; determining dimensions of the container based on the determined height of the liquid contained in the container; calculating the volume of the liquid stored in the container using the determined container dimensions based on a determined height of the liquid contained in the container. The calculated volume of liquid stored in the container is preferably output a processing system.

According to a seventh aspect of the invention, there is provided a device for monitoring liquid in a container, comprising temperature detection means for detecting temperature, movement detection means for detecting movement of the device; volume determination means for determining the volume of liquid in the container; wireless communication means for communicating with an external computing system; a power supply; and processing means for processing data from the temperature detection means, movement detection means and volume determination means, wherein the processing means is in communication with the wireless communication means.

### BRIEF DESCRIPTION OF THE DRAWINGS

Aspects of the invention will be described with reference to the drawings in which:

FIG. 1a is a perspective view from above of a device according to an embodiment of the invention;

FIG. 1b is a perspective view from below of the device of FIG. 1b;

FIG. 2 is a perspective view of the device according to an embodiment of the invention located on the underside of a container;

FIG. 3 is a schematic view of the internal components of the device of FIG. 1a according to an embodiment of the invention;

FIG. 4 is a schematic diagram of the system components;

FIG. 5 is a diagram showing the usage state of a container at stages in a supply chain;

FIG. 6a is a diagram of process steps of a dynamic sliding operation for control of a device component according to an embodiment of the invention;

FIG. 6b is a diagram of process steps of a time series forecasting operation for control of a device component according to an embodiment of the invention; and

FIG. 6c is a is a diagram of process steps of a dynamic sliding operation for control for a device component according to an embodiment of the invention.

### DETAILED DESCRIPTION

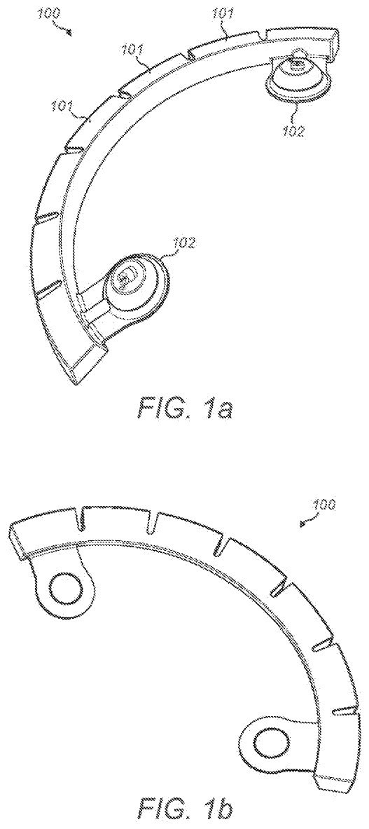

A device for monitoring the fluid contents of a container is shown in FIG. 1a. As can be seen, device 100 has a generally curved shape and comprises several segments. The segments are rigid and house electronic components, as will be described in further detail below. Device 100 as shown comprises seven segments, although it may comprise more segments or fewer segments. The number of segments may be dependent upon the number of different components to be housed by the device. The outer housing of device 100 is a flexible, water resistance and durable material, such as a thermoplastic elastomer. The segments are connected by the flexible outer housing and therefore the connections between the segments are deformable. This allows the device 100 to be flexed such that its angle of curvature can be varied. The material of the outer housing is also resilient such that the device will return to its original degree of curvature after deformation pressure has been removed.

Arms 102, generally located at the distal ends of device 100, extend in a radial direction. As shown, each arm comprises a component, although in alternative embodiments, the device may comprise only one arm, and in a further embodiment, only one arm may compromise a component. FIG. 1b shows the underside of the product. The underside is generally planar for direct contact with a substantially flat surface. The components comprised on arms 102 are at least partially exposed.

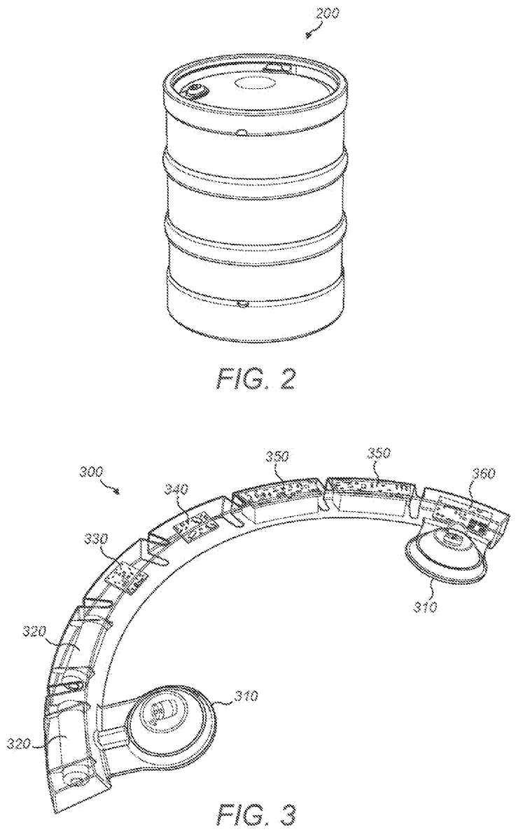

In FIG. 2, a container turned upside down is shown, with device 100 positioned under the bottom rim of the container. The container may be a barrel for storing a liquid, such as a keg for storing and transporting a consumable liquid product such as beer or ale. However, the device may be used to monitor any liquid product stored in any container, including casks, which typically store ale and wine and have a central width which is wider that the top and bottom of the cask. Typically, kegs are hermetically sealed stainless steel barrels which are generally cylindrical. Dimensions of kegs are widely standardised; in Europe, kegs are either 50 L, 30 L and 20 L (in specified heights and diameters); in the US, they are generally either 15.5 gallons (half-barrel), 7.75 gallons (quarter-barrel) or 5.17 gallons (sixth-barrel). The flexible outer enclosure of device 100 means that it can conform to fit within the rim of containers having different diameters.

Device 100 is typically secured to a keg while it is stored at a brewery prior to being filled. In this way the device can be retrofit to any existing keg. However, the device 100 may instead be affixed to a keg at the final stage of manufacture of the keg. As a further alternative, one or more components of the device may be built into the keg such that the device is integral to the keg. For example, one or more components of the device may be built into the rim portion of the keg.

In a preferred embodiment of the invention, device 100 is secured to container 200 by virtue of an interference fit; the height of device 100 is configured to be marginally greater than the height of the gap between the bottom end surface of the container and a lip which overhangs the bottom surface of the container, defining the rim. In an alternative embodiment, device 100 is adhered to the bottom end surface of the keg by any known means, such as glue. The adhesive used and/or means to affix device 100 to keg must withstand the high temperatures to which the keg is subjected during the cleaning process. Kegs are configured to be stacked on top of each other. By positioning device 100 in the rim such that it partially extends under the lip of the container, the location of device 100 does not interfere with the stacking of the containers.

FIG. 3 shows the main components of device 300. Device 300 comprises one or more long-life rechargeable batteries 320. The batteries are accessible such that they can be replaced by a user. One or more processing modules 350 are in communication with the other components of device 300 and instruct operation of the other modules in device 300, log data gathered by the other modules and instruct the transmittal of data by the low power wireless module according to a defined set of rules or pattern. As will be described in further detail below, the particular set of rules which determine module operation, data logging and data transmittal is dependent upon the usage state of the container to which device 300 is attached to.

Ultrasonic transducer transceiver 310, which may be an Audiowell US0014-001 transducer, is arranged to transmit and receive in a monostatic configuration. The signal is analysed by an analog front end component such as a TDC1000 by Texas Instruments, and the time of flight of the signal to be emitted, reflected from the surface of liquid in the container and to be received back is determined by a compatible development board. The more liquid in the container, the longer the time of flight. In an embodiment, device 100 comprises two transducers, such that one of the two can be used for redundancy (such that either both transducers are operational and the results and calculation from one transducers verifies the other, or such that one transducer is a ‘back up’ and becomes operational in the event that the other transducer fails). In an embodiment in which device 100 comprises only one transducer, the device includes only 1 arm. Alternatively, the second arm may comprise a battery. The transducer/s is/are enclosed in a stainless steel enclosure which is partially embedded within the outer flexible material in portions, or arms which extend from the main body of device 100. By virtue of their extension from the main body of the device on arms 102, the transducers are (when the device is in use and secured to a keg) in direct contact with the stainless steel of the bottom end surface of a keg, distanced from the side walls of the keg. This positioning facilitates a clear path for an ultrasonic signal to be sent across the length of the keg. In an alternative embodiment, two ultrasonic sensors (preferably operating at 1 Mhz and with an external clock frequency of 8 MHz) are used in a bistatic configuration.

Each different keg size will, when full, result in a particular time of flight measurement. After the keg is filled, but before it is tapped, the transducer and processing module is configured to determine the time of flight of an ultrasonic signal, as discussed above. The result is compared to the time of flight measurement of known keg sizes, which enables identification the type of keg the device is attached to, and therefore the volume of the keg. Knowledge of the volume of the keg (or its height and width) is used in later calculations for volume measurements when the keg is tapped; i.e. later time of flight measurements will be used in conjunction with the keg width or volume to determine the volume of liquid remaining in the keg or the percentage volume remaining in the keg. Alternatively, a time of flight measurement is taken when the keg is empty to deduce the height of the keg. The ultrasonic signal is reflected from the opposite end of the keg, i.e. the top end surface of the keg. The determined height is then compared with the heights of standard keg types, whose volume and width are known and can be similarly used in later volume measurement.

For a cask, device 100 is placed on the dispensing-end of the cask. The volume of liquid in the cask may be measured or approximated by using the accelerometer 330 (as discussed further below) or by a transducer. In general, casks are positioned so that they are lying on their side at a slight tilt (so that the dispensing end is at a lower height than the opposing end) when tapped—i.e. their contents are extracted by gravity (at least in part). For a fixed-incline scenario—i.e. when a cask is positioned for tapping at a fixed incline—a time-of-flight measurement using the transducer and accompanying analog front end and development board is used as a basis for a volumetric determination. Device 100 is positioned on the dispensing end of the cask such that the transducer is as close as possible to the pouring hole. It will be appreciated that in this variation, due to the position of the transducer, direction of the ultrasonic signal through the length of the cask and the tilt of the cask, accurate volume measurement is attainable only when the volume of liquid within the cask is within a range. It will also be appreciated that the range of the measurable volume is dependent upon the tilt angle—the greater the tilt angle, the greater the measurable volume range. For a specific angle of incline and size of cask, the relationship between volume and time of flight signal can be used to calibrate the time of flight signal and provide a volume determination (when the volume of liquid in the cask is within the measurable range). A cask may also be tapped when lying flat, and then subsequently tilted by a specific amount. When the cask is lying flat, ultrasonic volume measurement is not possible. When the pressure of the stream slows, the cask is tilted so that liquid continues to be dispensed from the pouring hole. Once tilted, volumetric determination is possible using time-of-flight, as discussed.

When using a cask tilt (a device that tilts the cask to by a greater angle as the liquid in the cask reduces), an accelerometer-based approach is adopted. An accelerometer is used to accurately measure the extent of the tilt and extrapolate the volume of liquid remaining in the cask on the basis that the greater the angle, the less the volume of liquid remaining. For a specific cask size, the relationship between volume and tilt angle can be used to calibrate the tilt angle and provide a volume determination. For casks which stand upright and which are pumped using a vertical ale extractor, the volume of liquid is measured based on the time of flight of an ultrasonic signal transmitted from the transducer, as discussed above for kegs.

Accelerometer 330 is arranged to measure a change in angle of the device, such as rolling, shaking or dropping and may be an MPU-6050 accelerometer. When a change in the angle is detected, the accelerometer informs the processing module 350 of the change as an interrupt signal.

Temperature sensor 340 is arranged to measure ambient temperature and may be a DHT22 sensor. As will be discussed further below, the temperature sensor is, according to a predetermined pattern of operation, configured to sense the ambient temperature at predefined time intervals. The sensed temperature is logged by the processing module.

Empty kegs undergo a high pressure and high temperature cleaning process at the end of every cycle. Device 100 optionally also comprises a thermoelectric component which is configured to harvest energy during the cleaning process (as a result of the Seebeck effect) and recharge the one or more batteries of device 100. Alternatively or additionally, device 100 comprises a piezoelectric component, wherein the piezoelectric component is configured to harvest kinetic energy and to recharge the batteries as the keg is moved. Device 100 may also include means for solar charging or inductive charging. In one embodiment, device 100 comprises an RF powered secondary battery, such as a supercapacitor (which may be used in conjunction with rechargeable battery 350) for RF energy harvesting. The transceiver of the wireless communication module (or a separate transceiver) converts received ambient radio signals (e.g. WiFi) into an AC or DC power feed to a secondary battery/supercapacitor. Alternatively or additionally, harvested power may be fed directly to the rechargeable battery. The harvested power can be used for both system operation and recharging of the rechargeable battery.

The low power wireless module is arranged, under instruction from the central processing module, to upload data to a cloud based computing system, such as Google Firebase. Such data include a unique identifier of the keg to which device 300 is attached, current or historical liquid volume with timestamps, current or historical temperature with timestamps and current or historical movement data with timestamps.

The low power wireless module transmits data to one or more gateways of a low power wide area network, such as Narrowband internet of things network, LTE-M or LoRaWAN. The low power wireless module may be a LoRa module with an ESP32 development board to transmit to a LoRaWAN gateway of an internet of things network. When the wireless module transits data, any available network gateways will receive the data and upload it to a cloud database, as discussed below. When data is received by a gateway, the gateway sends back to the wireless communication module metadata identifying the gateway, its location and the signal strength. The signal strength is used to estimate the proximity of the device to the gateway. The estimated distance of the device from the gateway is used in conjunction with the location of the gateway, to approximate the location of the device (using Collos Geolocation API for example). It will be appreciated that knowledge of various locations of interest (e.g. brewery, warehouse, retailer etc.) may simplify determination of the location of device 100. A determination as to the location of device 100 is therefore made when data is uploaded. In an alternative embodiment, device 100 includes a GPS module which is able to determine the location of the device using known GPS methodology.

The processing module is programmed to apply data correction rules in order to identify and discard measurements from the temperature, sensor, transducer and accelerometer that are outliers or spurious (e.g. a reading which suggests an increase in volume when the usage state of the keg is ‘tapped’).

Although not shown, device 300 may also include a light source, such as an LED, for providing a visual indication concerning battery power level, network connectivity, battery power mode or determined usage state (e.g. empty, untapped, tapped). Device 300 may also include a speaker for output of an audio notification similarly concerning battery power mode, usage state, etc. The processing module can be programmed to output a visual or audible alert when a geolocation determination identifies the keg as being outside of a defined area or geofence, when the temperature is above or below predefined values, and/or when the determined volume of liquid in the keg is below a threshold value. Similarly, the cloud based external computing system can output notifications concerning the same, in addition to making data uploaded from device 300 available and providing various data analytics as required.

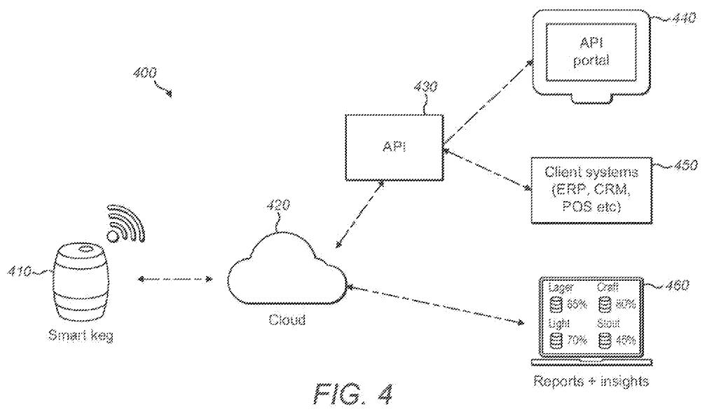

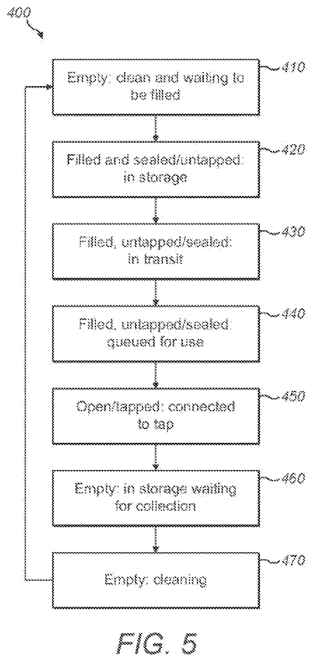

The system architecture 400 is shown generally in FIG. 4. The device secured to a keg (shown generally at 410) is in communication with cloud database 420. Data in cloud database 420 is exchanged with API 430, and such data is made available via API portal 440, as well as specific client systems. Data based on aggregated data is also available directly from cloud database 420 from cloud access 460. Data configurable to a user via the base platform API include acceptable temperature ranges, volume thresholds, keg types, liquid type and geolocation/geofence. Data accessible to a user via the API include real time and historic volume, temperature, location and movement. Such API access is dependent upon a user's access controls and will be dependent on a particular user (e.g. brewery, retailer, distributor) being granted access to data relating to particular devices/kegs. Data analytics based on aggregated data accessible via cloud access and/or API 430 and may relate to quality control and predicting consumption based on trends identified from historic data, using supervised learning techniques to help better inform and optimise selection, ordering, distribution and collection of beer and kegs, including inventory management, route optimisation, wastage management and product recalls.

FIG. 5 outlines the main stages through a fill-empty-fill lifecycle 400 of a keg. Each stage falls into one of three keg usage states: untapped, tapped and empty. At 410, an empty keg is typically stored at a brewery waiting to be filled. The accelerometer identifies any significant change in movement, and the low power wireless module is woken at predefined intervals to attempt to communicate with a proximal gateway to enable determination of the location of device 100. At this stage, device 100 may determine the size of the keg as discussed above. At 420, the keg is filled (and therefore ‘untapped’) and sealed and device 100 is secured to the keg. Preferably, the processing module of device 100 will already be programmed with the data identifying the contents of the keg. Temperature and movement sensing will occur according to an operation described below. The keg is stored at the brewery or may be transported to a warehouse or other distribution centre. At 430, the keg is transported to a retailer where it is stored and queued for use at 440. During transportation, temperature, movement are sensed regularly, and location is determined when the temperature data and movement data is uploaded. When the keg is queued for use, the volume is not expected to change (and therefore volume determination is made infrequently) but it is useful for temperature to be sensed regularly to monitor product quality. No movement or change in location is expected. At 450, the keg is tapped and the contents are consumed. At this stage, volume and temperature measurement will occur frequently, but location and movement less frequently. When the keg is empty or near-empty, it will be stored at the retailer before being collected and returned to a brewery (or distribution centre) for cleaning at 470. Location changes will be frequent when the empty keg is in transit.

Particular supply chain events which occur during the lifecycle of a keg, as generally described above with reference to FIG. 5, may be recorded using a blockchain. For example, events that may be recorded in a decentralised ledger are the date and time of departure from a warehouse and the temperature at that date and time, the time of arrival at a retailer and the temperature at that data and time, the date and time the keg is tapped and the temperature at that date and time and the date and time of a interrupt signal from the accelerometer indicating that the keg had been shaken etc.

To optimise battery life, it is desirable to operate components of device 11 only when necessary and/or when useful data may be gathered from such operation. For example, during the ‘tapped’ usage state of the keg, the volume of the contents of the keg are diminishing at a relatively high rate such that regular volume measurements are useful, but it is generally not (although may be in some specific circumstances) necessary to make frequent determinations as to the location of device 100. Conversely, when an empty keg is being transported from the retailer back to a storage location or brewery, volume measurements are not necessary because the keg is empty but location information is useful and therefore the location of device 100 is determined regularly. By applying a pattern of operation for some sensors, and throughout the lifecycle of the keg, power usage can be minimised, thereby extending the life of the batteries in the device.

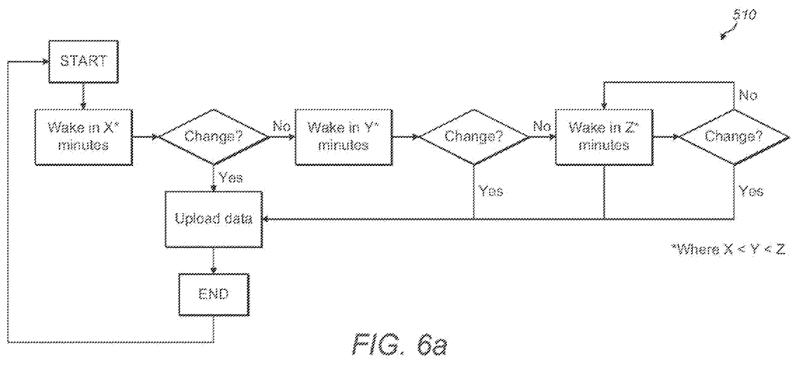

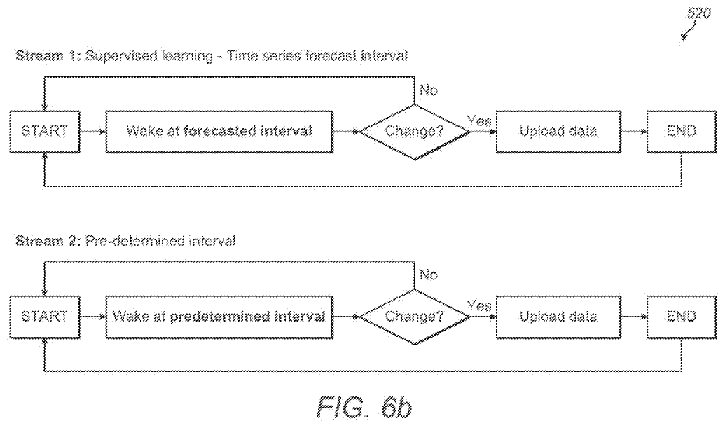

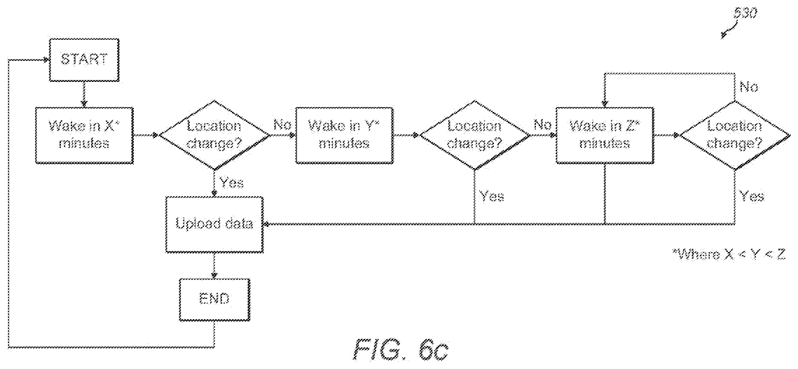

FIG. 6a shows a sliding mode control process 510 for determining the frequency of temperature sensor operation when the usage state of the keg is untapped. Process 510 applies at stages 420, 430 and 440 of FIG. 5. A sliding mode control is based on the dynamic adjustment of time intervals depending on a change detected which indicates a deviation from a default state or value. Process 510 shows three different time interval, X, Y and Z, where X is less than Y and Y is less than X. A starting time period is defined by X, such that after X minutes, a measurement is taken and a determination is made as to whether the measurement indicates a change in a default state. If there is a change, the processing module instructs the uploading of the data, and another measurement is taken after X minutes. If there is no change, a measurement is taken after Y minutes, wherein Y is greater than X. If a change is detected after Y minutes, data relating to the measurement is uploaded, and the measurement will be taken again after X minutes. If there is no change, a measurement will be taken in Z minutes, where Z is greater than Y. If there is a change, data relating to the change is uploaded and the next measurement will be taken in X minutes. If there is no change, the next measurement will occur after Z minutes. The number of possible time intervals, and the time intervals themselves, are configurable. When the keg is in an ‘untapped’ usage state, movement events are based on an interrupt, and the lower power wireless module is on so that it is always detecting the presence of an internet of things gateway. If the accelerometer detects a predefined movement (which indicates that the keg is being tapped), the processing module will instruct the transducer and associated development board to calculate the volume of liquid in the container according to the process described with reference to FIG. 6b.

FIG. 6b shows a sliding mode control process 520 for determining the frequency of transducer and associated development board operation when the usage stage of the keg is tapped, and therefore applies at stage 450. Volume changes in this state will occur frequently and usually according to a set pattern (e.g. there will likely be a greater rate of change during evening hours compared to afternoon hours, and likely little or no change during morning hours). A ‘forecasted interval’ is a time interval which has been set based on historic data and will usually be based on the predicted pattern of when volume changes are expected. In this state, ‘time series forecasting’ is used in conjunction with operation/measurement at regular intervals, shown in FIG. 6b as X minutes. Therefore, the transducer will take measurement every X minutes irrespective of the forecasted interval. Any volume change will be uploaded. When the keg is in a tapped state, temperature may be sensed at regular but infrequent intervals, location determination will be disabled and movement detection will again be based on an interrupt signal from the accelerometer. Whether or not process 520 occurs may be dependent upon whether or not the user (which may be a brewery or retailer, for example) has requested volume monitoring.

FIG. 6c shows a sliding mode control process 530 for determining the frequency of determination of the location of device 100. In an empty state, volume and temperature are not measured. Process 530 applies at stages 410, 460 and 470. Process 530 is similar to process 510. To conserve battery power, the low power wireless module is disabled by default when the keg is empty. However, as shown in process 530, the low power wireless module is woken to detect internet gateways after X minutes, and if none are detected, it goes to sleep again until Y minutes have passed, at which time it wakes again. The next wake up interval is Z minutes if no gateways are detected. If gateways are detected, the relevant data is uploaded and the module sleep again until X minutes have passed.

The device described could be used in conjunction with any container that stores liquid consumable product such as beer, ale, cider, wine, cocktails, vaccines, fuel, oxygen, carbon dioxide, nitrogen, etc.

1. A device for attaching to a container for storing a fluid,
wherein the device comprises:
one or more sensors for measuring a parameter of the fluid or the container; and
multiple segments, wherein the multiple segments are connected by a flexible material,
wherein the device has a flexible outer construction for conforming to curvature of an upper or lower rim of a container having a substantially cylindrical or barrel shape.

2. The device of claim 1, wherein the device has a generally arcuate shape having a degree of curvature.

3. The device of claim 2, wherein the flexible material allows the degree of curvature to be varied.

4. The device of claim 1, wherein a first segment houses a processing unit, a second segment houses a wireless communication module, a third segment houses a power source and a fourth segment houses one of an accelerometer and a temperature monitor.

5. The device of claim 1, further comprising an ultrasonic transducer transceiver.

6. The device of claim 5, wherein the device comprises one or more radial arms, wherein at least one of the one or more radial arms comprise the ultrasonic transducer transceiver, such that, when the device is positioned under a rim of a container, the one or more radial arms extend towards the central longitudinal axis of the container.

7. The device of claim 1, further comprising a supercapacitor, wherein the supercapacitor is configured to stored RF power harvested from ambient or dedicated radio signals.

8. The device of claim 1, further comprising a thermoelectric generator, wherein the thermoelectric generator is configured to charge the at least one battery during cleaning of the container.

9. The device of claim 1, further comprising a piezoelectric component, wherein the piezoelectric component is configured to harvest kinetic energy during movement of the container.

10. A device for monitoring liquid in a container, comprising:
temperature detection means for detecting temperature;
movement detection means for detecting movement of the device;
volume determination means for determining the volume of liquid in the container;
wireless communication means for communicating with an external computing system; and
processing means for processing data from the temperature detection means, movement detection means and volume determination means, wherein the processing means is in communication with the wireless communication means;
wherein the processor means is configured to control the operation of the temperature detection means, movement detection means and volume determination means and transmit data to the external computer system according to a set of rules, wherein the set of rules is determined based on the usage state of the container.

11. The device of claim 10, wherein in a first usage state, the data is collected and transmitted according to a sliding mode control process.

12. The device of claim 10, wherein in a second usage state, the data is collected and transmitted according to a time series forecasting process.

13. The device of claim 10, wherein the usage state of the device is determined based on an interrupt event detected by the movement detection means.

14. The device of claim 10, wherein the usage state of the device is determined based on a change in a measurement of the volume of the liquid in the container by the volume determination means.

15. The device of claim 10, wherein when the container is in a first usage state, the processing means is configured to instruct the volume detection means to detect volume according to a time series forecasting pattern.

16. The device of claim 10, wherein in a second usage state, the processing means is configured to instruct the movement detection means to determine the movement of the contents of the container according to a sliding mode control process.

17. The device of claim 10, wherein in a third usage state, the processing means is configured to instruct the temperature detection means to determine the temperature of the contents of the container according to a sliding mode control process.

18. A container for liquid comprising a device according to claim 1.

19. A system for power conservation for a device, wherein the system comprises:
a device for monitoring the liquid contents of a container, and
an external computing system,
wherein the device comprises:
temperature sensing means for sensing temperature;
movement detection means for detecting movement of the device;
volume determination means for determining the volume of liquid in the container;
wireless communication means for communicating with an external computing system; and
processing means in communication with the communication means, wherein the processing means is configured to control the operation of the temperature detection means, wireless signal detection means, movement detection means and volume determination means, store and transmit data to the external computer system according to a set of rules, wherein the set of rules is determined based on the usage state of the device.

20. The system of claim 19, wherein the external computing system is configured to receive location data relating to one or more network gateways proximal to the device.

21. The system of claim 20, wherein the external computing system is further configured to receive data relating to the signal strength of a signal transmitted from the wireless communication module and received by the network gateway.

22. The system of claim 21, wherein the external computing system is configured to determine a location of the device based on the signal strength and data relating to the location of the one or more network gateways.

23. The system of claim 19, wherein the communication means communicates with the external computing system using an internet of things network.

24. The system of claim 19, wherein the wireless communication means is configured to detect a wide area network gateway.

25. A method of power management for a device for monitoring the liquid contents of a container, comprising:
determining a usage state of the device, wherein
if is it determined that the device is in the first usage state, recording or measuring a first parameter of the contents of the container and transmitting the parameter to an external computing system according to a sliding mode control process, and
if it is determined that the device is in a second usage state, recording or measuring a parameter of the contents of the container and transmitting the parameter to an external computing system according to a time series forecasting process.

26. The method of claim 25, wherein the first parameter is temperature and the second parameter is volume.

27. A system for determining the volume of liquid contained in container, comprising:
a device arranged to measure the time of flight of an ultrasonic signal reflected from a surface of the liquid contained in the container, and to transmit the time of flight data to an external computing system;
an external computing system in communication with the device, wherein the external computing system is arranged to store dimensions of multiple types of container, wherein the external computing system is further configured to:
receive the time of flight data,
determine the height of the liquid contained in the container based on the time of flight data,
determine dimensions of the container based on the determined height of the liquid contained in the container, and
calculate, for a determined height of the liquid contained in the container, the volume of the liquid stored in the container using the determined keg dimensions.

28. A method of monitoring a liquid contained in a container, comprising:
emitting an ultrasonic signal from the bottom of the container and receiving the signal at the bottom of the container, reflected by an interface between gas and liquid at the surface of the liquid contained in the container;
determining the height of the liquid contained in the container;
determining dimensions of the container based on the determined height of the liquid contained in the container;
calculating the volume of the liquid stored in the container using the determined container dimensions based on a determined height of the liquid contained in the container.
